(19) United States
(12) Patent Application Publication
(10) Pub. No.: US 2016/0095423 A1
(43) Pub. Date: Apr. 7, 2016

(54) SPRAYER BRUSH

(71) Applicant: Progressive International Corporation, Kent, WA (US)

(72) Inventor: Jennifer K. Cotter, Seattle, WA (US)

(21) Appl. No.: 14/861,559

(22) Filed: Sep. 22, 2015

Related U.S. Application Data
(60) Provisional application No. 62/059,556, filed on Oct. 3, 2014.

(51) Int. Cl. A46B 11/00; B05B 15/06; A46B 15/00; B05B 11/00

(52) U.S. Cl. CPC A46B 11/00; B05B 11/0037; B05B 15/06; A46B 15/00

(57) ABSTRACT

A combination sprayer brush includes a spray bottle removably attached to a body having a brush. The spray bottle includes a removable cap and a spray nozzle allowing fluid within the spray bottle to be sprayed as desired. The body for the brush may include opposing sidewalls and an open first end allowing the bottle to be inserted into the open first end, with the cap and nozzle of the bottle extending beyond the sidewalls.

### PRIORITY CLAIM

This application claims the benefit of prior U.S. provisional application No. 62/059,556, filed Oct. 3, 2014, the contents of which are incorporated by reference.

### FIELD OF THE INVENTION

This application relates generally to cleaning devices, particularly including brushes.

### BACKGROUND OF THE INVENTION

Fruits and vegetables often require cleaning before consumption, and in some instances a brush is required to aid in scrubbing them clean. Water from a faucet is often sufficient to clean the food item, but in some cases a cleaning fluid of some sort is better, such as a mix of vinegar, water, and orange peel as an example of an organic cleaning mixture. Such a mixture, for example, is useful for cleaning away pesticides and chemicals that may be found on the fruit or vegetable. Though spray bottles for such uses are readily available, there is no combination spray bottle and brush that is retained together for designated use for this purpose.

### SUMMARY OF THE INVENTION

In a preferred example of the invention, a combination sprayer brush includes a spray bottle removably attached to a body having a brush. The spray bottle includes a removable cap and a spray nozzle allowing fluid within the spray bottle to be sprayed as desired.

In one version of the invention, the body for the brush includes opposing sidewalls and an open first end allowing the bottle to be inserted into the open first end. In some versions, the opposing second end terminates in an annular seat forming an opening at the second end, but in which the spray bottle cannot pass through the opening at the second end.

In an example of the invention, the opposing sidewalk are separated by a gap at a location opposite the bristles forming the brush. Optionally, the spray bottle includes a raised portion that engages a surface on one or both of the opposing sidewalls to impede rotation of the spray bottle within the body. In yet other versions of the invention, the spray bottle and brush include other forms of complementary surfaces that prevent rotation of the bottle within the body.

In a version of the invention, the second end of the body includes a short circular sidewall portion to further prevent the bottle from falling out of the body.

In some examples of the invention, two separate sets of bristles are provided on the brush, including one set that is relatively soft and one set that is relatively firm. The two sets of bristles may be formed from different materials, such as silicone for the soft bristles and nylon for the firm bristles.

In a preferred version, the bottle and brush are configured so that the cap and nozzle extend beyond the body when the bottle is inserted into the body. In one such example, the height of the bottle is sufficiently greater than that of the body so that the cap extends beyond the body. In other versions, the body forms a seat for the bottle, in which the location of the seat is designed to ensure that the cap and nozzle extend beyond the body.

### BRIEF DESCRIPTION OF THE DRAWINGS

Preferred and alternative examples of the present invention are described in detail below with reference to the following drawings.

FIG. 1 is a top perspective view of a preferred sprayer brush.

FIG. 2 is a right side view of a preferred sprayer brush.

FIG. 3 is a top front exploded view of a preferred sprayer brush, shown with a spray bottle separated from a brush.

FIG. 4 is a top rear exploded view of a preferred sprayer brush.

FIG. 5 is a top plan view of a preferred sprayer brush.

### DETAILED DESCRIPTION OF THE PREFERRED EMBODIMENT

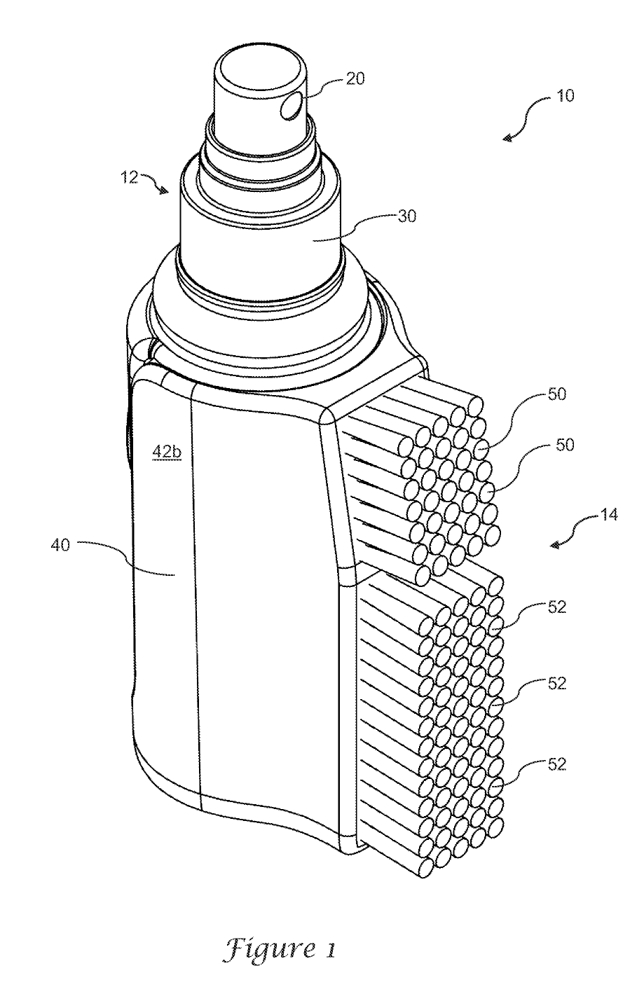

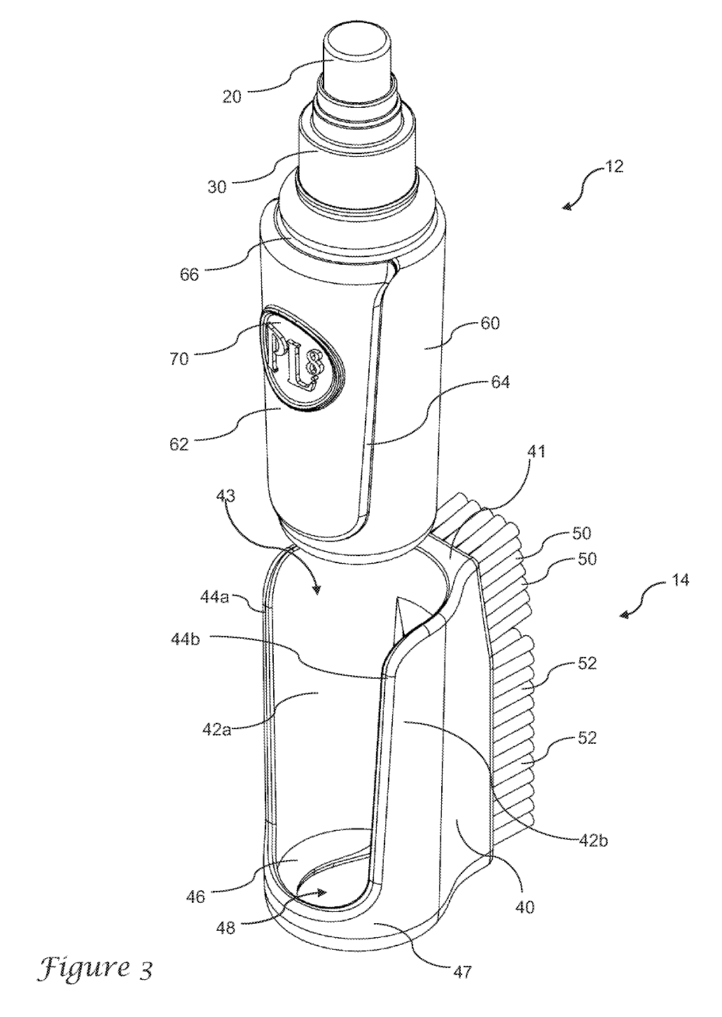

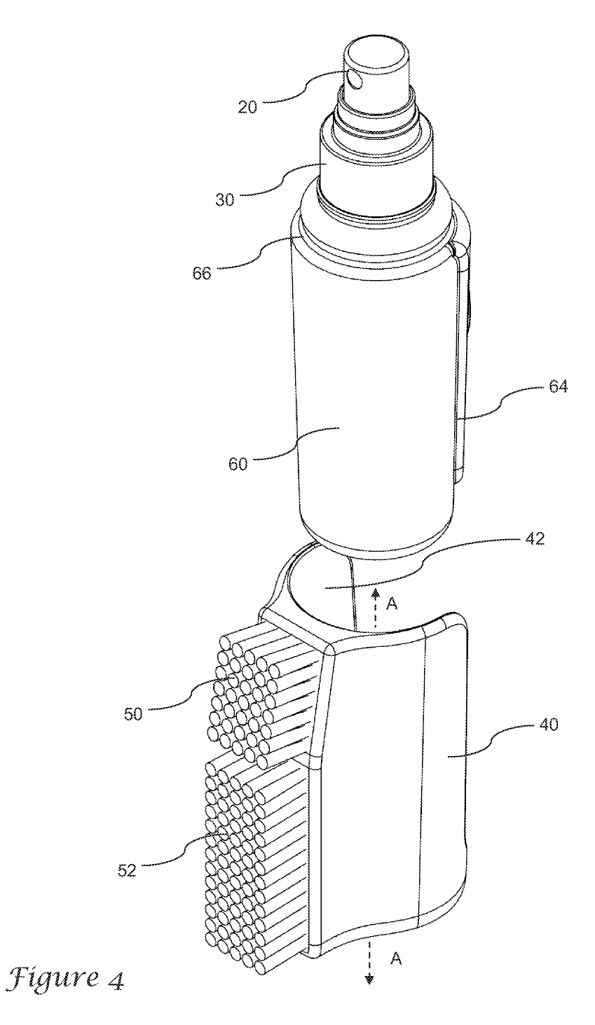

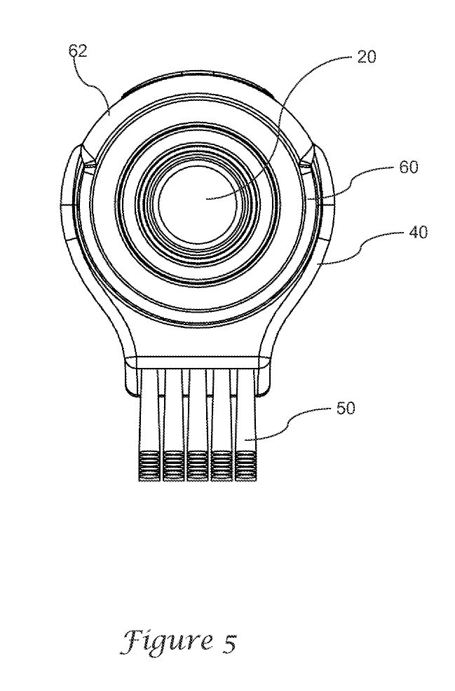

A sprayer and brush is illustrated in combination in FIGS. 1, 2, and 5, and separated from one another in the exploded views of FIGS. 3 and 4. In the illustrated example, the combination sprayer and brush 10 includes a sprayer 12 which is removably attached to a brush 14.

As best seen in the exploded views of FIGS. 3 and 4, the sprayer portion 12 includes a spray bottle 60, which in the illustrated example is configured as a generally cylindrical bottle formed from plastic or other materials. The bottle includes an open top forming a neck having a mouth to enable the bottle to be filled with water or another liquid. A standard sprayer having a nozzle head 20 is attached to a threaded cap 30 so that the nozzle head may be attached to or removed from the bottle by screwing or unscrewing the threaded cap from mating threads formed on the neck of the bottle. In the illustrated version, the threads are internal and not shown within the cap 30. The nozzle head 20 preferably includes a tube (not shown) extending from the nozzle head into the bottle 60 to draw liquid from the bottle to the nozzle head for spraying.

The brush 14 includes a body 40 configured for grasping by a hand of a user and having a number of bristles. The body 40 of the brush is formed with sidewalls 42a, 42b defining an interior space for receiving the bottle 60 of the sprayer 12. In a version in which the bottle is substantially cylindrical, the sidewalk preferably also form a substantially cylindrical internal space to snugly receive the exterior surface of the bottle.

In one example of the invention, the body 40 of the brush is open substantially along a side opposite the location of the bristles, as best seen in FIG. 3. In the preferred version as illustrated, a base portion 41 of the body of the brush is configured with a plurality f bristles. The base portion transitions to a pair of opposing sidewalls 42a, 42b, which curve around to form an interior space for receiving a generally cylindrical bottle 60.

The cylindrical sidewalls are further formed with a first open end 43 sized to receive the bottle and to allow the bottle to be removed through the first open end. The opposing second end 48 of the body portion includes an inward-facing seat 46 that serves as a stop to prevent the bottle from sliding laterally beyond the seat. In one version, the seat is generally annular in shape, extending inward substantially around the entire second end of the main body. Optionally, the seat 46 is formed with a central opening, which may be sized to allow a user to push the bottle out of the body by inserting a finger through the opening in the second end 48. In other versions the second end of the body is fully enclosed.

The opposing sidewails 42a, 42b in the illustrated example extend outward from the base portion 41 to form a space for receiving the bottle as described above, but in the (preferred version the two sidewalk stop short of one another, defining a gap between the opposing sidewall terminal edges 44a, 44b. Most preferably, a lower portion of the body adjacent the second end 48 includes a sidewall portion 47 which substantially encircles the bottom of the bottle when the bottle is inserted into the main body.

The bottle 60 optionally includes a raised portion 62, which extends radially outward from the otherwise generally cylindrical surface of the bottle along a portion of the outer surface. In one example, the raised portion 62 is sized and configured to fit within and substantially fill the gap defined by the opposing sidewall terminal edges 44a, 44b when the bottle is inserted into the body. The raised portion as illustrated extends from approximately the bottom of the bottle and continues upward to about the top shoulder 66 of the bottle, where it transitions to the neck for receiving the cap 30. In an example in which the body includes a lower central sidewall portion 47, preferably the raised portion 62 on the bottle will terminate above the bottom of the bottle, so that it is complementary with the shape of the central opening in the main body.

Accordingly, the edges 64 of the raised portion 62 will abut the terminal edges of the sidewalls, thereby preventing the bottle from rotating within the body of the brush and generally holding the bottle in a fixed position. As a result, the nozzle of the bottle can be oriented in a desired direction without inadvertently rotating, ensuring that the nozzle is directed to spray outward in the direction generally aligned with the outward direction of the bristles. It should be appreciated that other features for interacting between the body and the bottle are possible in order to prevent rotation of the bottle with respect to the body, though the above-described mechanism is preferred because the gap and raised portion are large and visible, making the correct orientation readily visible and easy to achieve. In general, most preferably the bottle includes at least one outer surface that engages at least one complementary surface on the body to prevent rotation of the bottle within the body. In a further preferred version, a visible emblem 70 or other indicator is positioned in the region of the raised portion to further provide a visual orientation indicator.

A brush formed from a plurality of bristles is carried on the main body 40. In the illustrated example, as shown in FIG. 4, the bristles are oriented to be extending from the main body in a direction generally radially away from a central axis A defined by the center of the space formed by the sidewalk 42a, 42b. In addition, the bristles are generally directed diametrically away from the gap defined by the terminal edges of the sidewalls.

In one version of the invention, two distinct brush sections are provided, including a first brush section with bristles 52 oriented perpendicularly to the central axis A, and a second brush section with bristles 50 inclined slightly (between about 10 degrees and about 20 degrees) with respect to the bristles of the first brush section. In other versions, a single brush section may be incorporated, or the bristles may be configured with other orientations.

The bristles in the preferred brush sections may be formed from food-grade silicone in one version of the invention. In other versions, they may be formed from nylon or other synthetic materials suitable for working with foods. In a preferred example, one of the sets of bristles is relatively softer than the other set of bristles.

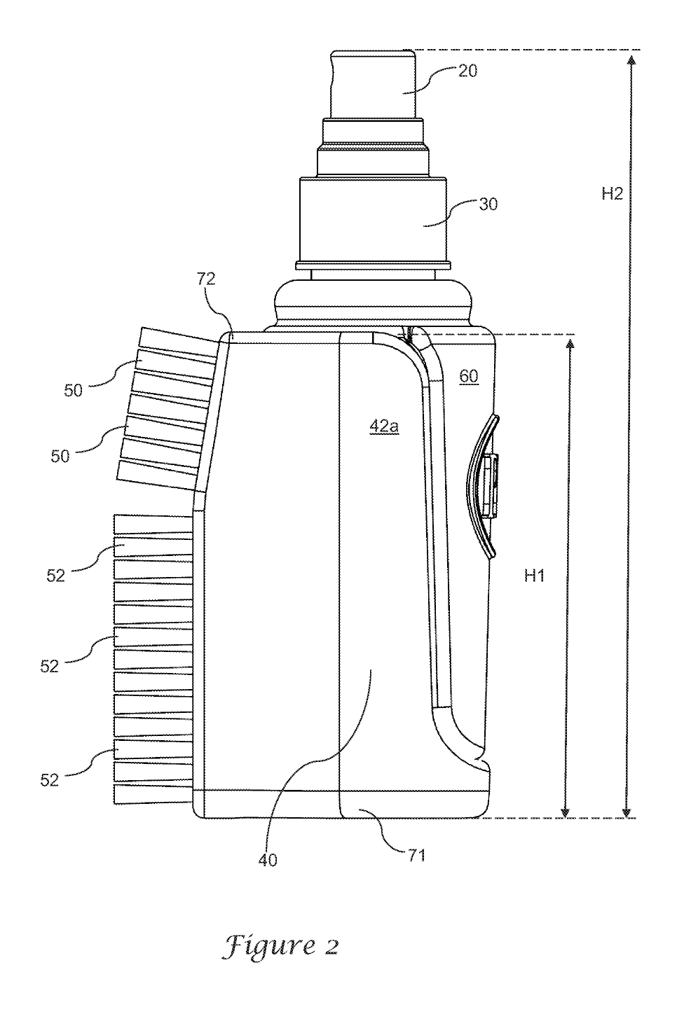

As illustrated for example in FIG. 2, the body 40 of the brush preferably defines a first height H1 from the first end or top 72 to the second end or bottom 71. When the bottle is fully inserted into the body and the bottom of the spray bottle is adjacent the bottom of the body, the top of the sprayer bottle, at the nozzle 20, extends along a second height H2 which is greater than the first height H1. As illustrated, the height of the bottle is preferably greater than that of the brush. Most preferably, the cap 30 is positioned outside the area defined by the sidewails when the bottle is inserted into the body. In this configuration, the bottle cap and nozzle are accessible by a user even when the bottle is in position, attached to the brush.

In use, the spray bottle can be used to spray water or other fluids contained within the bottle, and in one example the bottle can spray water toward a vegetable to be cleaned. The brush can then be used to scrub dirt or other impediments from the vegetable, with additional steps of spraying and brushing repeated as desired or necessary. Because the bottle can be inserted into the brush body, the steps of scrubbing and spraying can be accomplished with the bottle and brush attached to one another, and in which the vegetable is held in one hand while the combined bottle and brush are held in the other hand. The bottle can later be removed from the brush body for cleaning if desired.

The combined brush and bottle provides for a convenient cleaning device, and makes the combination more readily portable for use away from home. It allows for use of water as a cleaning fluid, or for use of a commercial or home-made cleaning fluid.

Similarly, the brush and bottle can be used for other cleaning tasks, such as for spraying a cleaning solution on a countertop and then using the brush to scrub the area to be cleaned.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A sprayer brush, comprising:
a spray bottle having a cap and a spray nozzle; and
a brush having a body with a base and a first set of bristles extending from the base, the spray bottle being removably attached to the base.

2. The sprayer brush of claim 1, wherein the body further comprises a first end, a second end, and sidewalls extending between the first end and the second end, the sidewalls defining an interior space for removably receiving the spray bottle.

3. The sprayer brush of claim 2, wherein the first end of the body defines an opening, the spray bottle being insertable through the opening to selectively remove the spray bottle from the brush and attach the spray bottle to the brush.

4. The sprayer brush of claim 3, wherein the spray bottle further comprises a spray bottle surface and the body comprises a body surface, the spray bottle surface engaging the body surface when the spray bottle is attached to the brush to impede rotation of the spray bottle with respect to the brush.

5. The sprayer brush of claim 3, wherein the sidewalls further comprise terminal edges defining a gap extending from the open first end of the body toward the second end of the body, and further wherein the spray bottle includes a projection formed on an outer surface of the spray bottle, the projection being configured to engage at least one of the terminal edges to impede rotation of the spray bottle with respect to the brush.

6. The sprayer brush of claim 5, wherein the second end of the body is formed with an annular seat having a central opening.

7. The sprayer brush of claim 5, wherein the gap is positioned diametrically opposite the first set of bristles.

8. The sprayer brush of claim 5, further comprising a second set of bristles, the first set of bristles being formed from silicone and the second set of bristles being formed from nylon.

9. A sprayer brush, comprising:
a spray bottle having a bottom end and an opposing top end terminating in a cap with a spray nozzle; and
a brush having a body with a base and a first set of bristles extending from the base, the body having a bottom end and a top end;
the spray bottle being removably attached to the base, wherein the cap and the spray nozzle extend beyond the top end of the body when the spray bottle is attached to the base.

10. The sprayer brush of claim 9, wherein the body further comprises pair of sidewalls extending between the bottom end and the top end of the body, the sidewalls defining an interior space for removably receiving the spray bottle.

11. The sprayer brush of claim 10, wherein the top end of the body defines an opening, the spray bottle being insertable through the opening to selectively remove the spray bottle from the brush and attach the spray bottle to the brush.

12. The sprayer brush of claim 11, wherein the body further comprises a seat positioned within the interior space defined by the sidewalls, the seat engaging the bottom end of the spray bottle when the spray bottle is fully inserted into the body, wherein the cap and the nozzle extend outside of the interior space defined by the sidewalls when the spray bottle is fully inserted into the body.

13. The sprayer brush of claim 12, wherein the spray bottle further comprises a spray bottle surface and the body comprises a body surface, the spray bottle surface engaging the body surface when the spray bottle is attached to the brush to impede rotation of the spray bottle with respect to the brush.

14. The sprayer brush of claim 12, wherein the sidewalls further comprise terminal edges defining a gap extending from the top end of the body toward the bottom of the body, and further wherein the spray bottle includes a projection formed on an outer surface of the spray bottle, the projection being configured to engage at least one of the terminal edges to impede rotation of the spray bottle with respect to the brush.

15. The sprayer brush of claim 12, wherein the seat is formed as an annular seat having a central opening.

16. The sprayer brush of claim 12, wherein the gap is positioned diametrically opposite the first set of bristles.

17. The sprayer brush of claim 12, further comprising a second set of bristles, the first set of bristles being relatively softer than the second set of bristles.

18. The sprayer brush of claim 12, wherein the first set of bristles is formed from silicone and the second set of bristles being formed from nylon.
